(19) United States
(12) Patent Application Publication
(10) Pub. No.: US 2008/0271107 A1
(43) Pub. Date: Oct. 30, 2008

(54) IN-HOME RECEIVING TERMINAL SYSTEM

(75) Inventors: Kenji SHIOYAMA, Kyoto (JP); Nobuhiko ARASHIN, Osaka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/109,181

(22) Filed: Apr. 24, 2008

(30) Foreign Application Priority Data
Apr. 24, 2007 (JP) 2007-113876

(51) Int. Cl. H04N 7/173

(52) U.S. Cl. 725/131

(57) ABSTRACT

Provided is an in-home receiving terminal system capable of detecting that a receiving terminal device is outside a subscriber's house, and restricting viewing of cable television broadcasting by the receiving terminal device outside the subscriber's house. In the in-home receiving terminal system comprising a main terminal device and a sub-terminal device for receiving digital cable television broadcasting, the main terminal device and the sub-terminal device being connected to an in-home network, a link detecting portion of the sub-terminal device detects the status of a link connection with the in-home network, and a terminal control portion of the sub-terminal device controls activation/deactivation of a television reception tuner based on the detected status of the link connection.

### FIELD OF THE INVENTION

The present invention relates to an in-home receiving terminal system consisting of a plurality of receiving terminal devices under the cable television subscriber contract.

### BACKGROUND OF THE INVENTION

As for cable television broadcasting, it is often the case that one receiving terminal device is used per subscriber contract. In recent years, however, an increasing number of subscribers are using a plurality of receiving terminal devices per contract for the purpose of viewing programs in different rooms or multichannel viewing. For such subscribers, cable television broadcasters rent a plurality of receiving terminal devices.

However, under such a subscriber contract with a plurality of receiving terminal devices, subscribers are charged by the number of receiving terminal devices, and therefore they have to pay a high fee which seems to be relatively expensive. Accordingly, cable television broadcasters set contract systems in which rental fees for the second and subsequent receiving terminal devices are maintained low, thereby eliminating the perception of relative expensiveness and promoting subscriber contracts with a plurality of receiving terminal devices.

In the same coverage area, such as the same local area or the same collective housing, television broadcasting is transmitted over a cable television circuit. Accordingly, users can view television broadcasting by connecting their receiving terminal devices conforming to a reception scheme protected by CAS (conditional access system) to the cable television circuit. Cable television broadcasters rent as many receiving terminal devices as those under contract to users who each have agreed to use the receiving terminal devices in the same house.

FIG. 4 illustrates a general configuration of a cable television broadcasting system. An in-home receiving terminal system 10b installed in the house of a subscriber (a CATV subscriber's house) consists of one main terminal device 400, and one or more sub-terminal devices 500. The main terminal device 400 and each sub-terminal device 500 are connected to a cable television broadcasting station 20 via a cable television circuit 30.

In the case of such a cable television broadcasting system, even without obtaining permission from the cable television broadcaster (the cable television broadcasting station), the subscriber has a chance to lend one of the rental receiving terminal devices (the sub-terminal device 500) to a non-subscriber (a non-CATV-subscriber) having the cable television circuit 30 installed in his/her house, as indicated by the dotted arrow in FIG. 4. In this case, the subscriber or the non-subscriber unfairly views cable television broadcasting without paying the fee for one receiving terminal device that should normally be paid to the cable television broadcaster. That is, the receiving terminal device under contract is unfairly used, so that the cable television broadcaster is not able to receive a legitimate fee.

There have been proposed some techniques for preventing a plurality of receiving terminal devices rent by the cable television broadcaster to the subscriber for use in the same house from being unfairly used against the contract (see, for example, Japanese Laid-Open Patent Publication No. 10-322676). In such a technique, the receiving terminal devices rented to the subscriber are managed as the main terminal device and the sub-terminal device. The main terminal device and the sub-terminal device are capable of preventing cable television programs, etc., from being unfairly copied or from being viewed by any receiving terminal device other than the devices which are allowed to be used for viewing the programs under contract. On the other hand, recorded programs can be freely viewed in the subscriber's house.

FIG. 5 illustrates the configuration of an in-home receiving system 10c described in the aforementioned document. A scrambled television program is distributed to a main terminal device 600 in the subscriber's house via a cable television circuit. The main terminal device 600 generates a viewing key for viewing the scrambled television program, thereby allowing the user to view the television program. In addition, the main terminal device 600 generates another viewing key containing a sub-terminal-device viewing permission ID for managing a sub-terminal device 700, and notifies the sub-terminal device 700 of the viewing key.

Based on the viewing key and its own unique ID, the sub-terminal device 700 determines whether it has a predetermined relationship with the main terminal device 600. If it is found to have the predetermined relationship with the main terminal device 600, the sub-terminal device 700 descrambles the television program distributed by way of the main terminal device 600, so that the user can view the program. However, such viewing restrictions based on the viewing key are not effective if any sub-terminal device unfairly lent to the non-subscriber is on the cable television circuit.

### BRIEF SUMMARY OF THE INVENTION

Therefore, an object of the present invention is to provide an in-home receiving terminal system capable of restricting viewing of cable television broadcasting by any receiving terminal device outside the subscriber's house.

To attain the above object, the present invention provides an in-home receiving terminal system comprising a main terminal device and a sub-terminal device for receiving digital cable television broadcasting, the main terminal device and the sub-terminal device being connected to an in-home network,

wherein the sub-terminal device includes:
a tuning unit for receiving the digital cable television broadcasting;
a link detecting unit for detecting the status of a link connection with the in-home network; and
a terminal control unit for controlling activation/deactivation of the tuning unit based on a notification from the link detecting unit, regarding the status of the link connection.

In the present invention, when the status of the link connection between the sub-terminal device and the in-home network is detected and the link connection is found not to be established, the television receiving function of the sub-terminal device is deactivated. According to the present invention, a relatively simple operation of detecting the status of the link connection with the in-home network prevents unfair reception by the sub-terminal device.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram illustrating the basic configuration of an in-home receiving terminal system according to the present invention.

FIG. 2 is a block diagram illustrating a concrete configuration of the in-home receiving terminal system shown in FIG. 1.

FIG. 3 is a sequence chart for a main terminal device and a sub-terminal device in the in-home receiving terminal system shown in FIG. 1 to establish a link connection with an in-home network.

FIG. 4 is a diagram for describing unfair use of the sub-terminal device in a cable television broadcasting system.

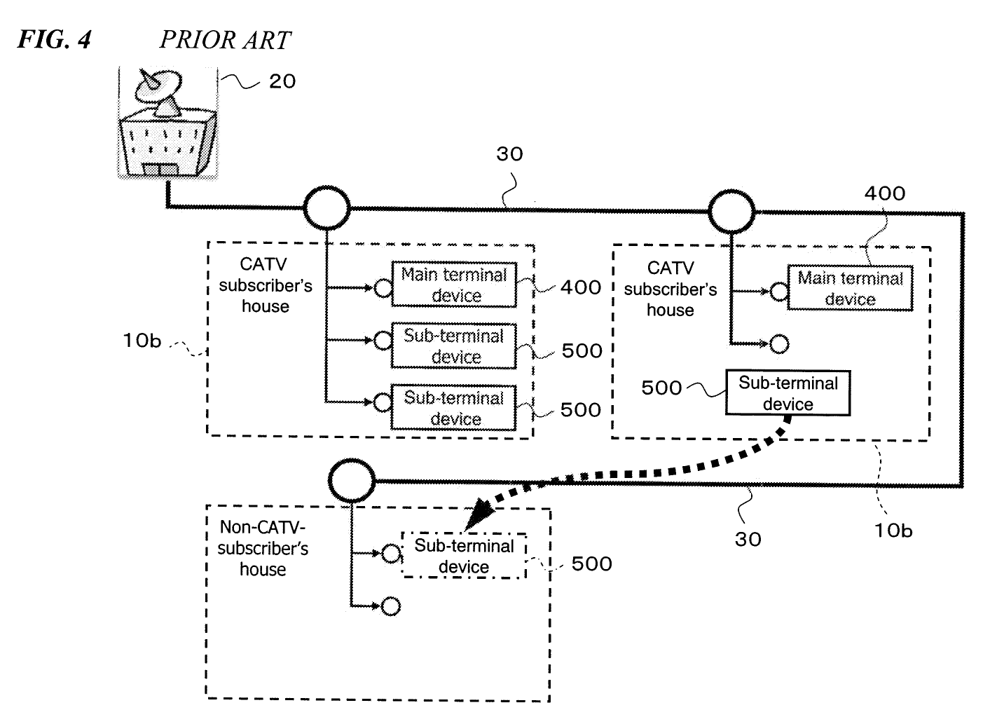

FIG. 5 is a block diagram illustrating a configuration for preventing unfair use of a sub-terminal device in a conventional in-home receiving terminal system.

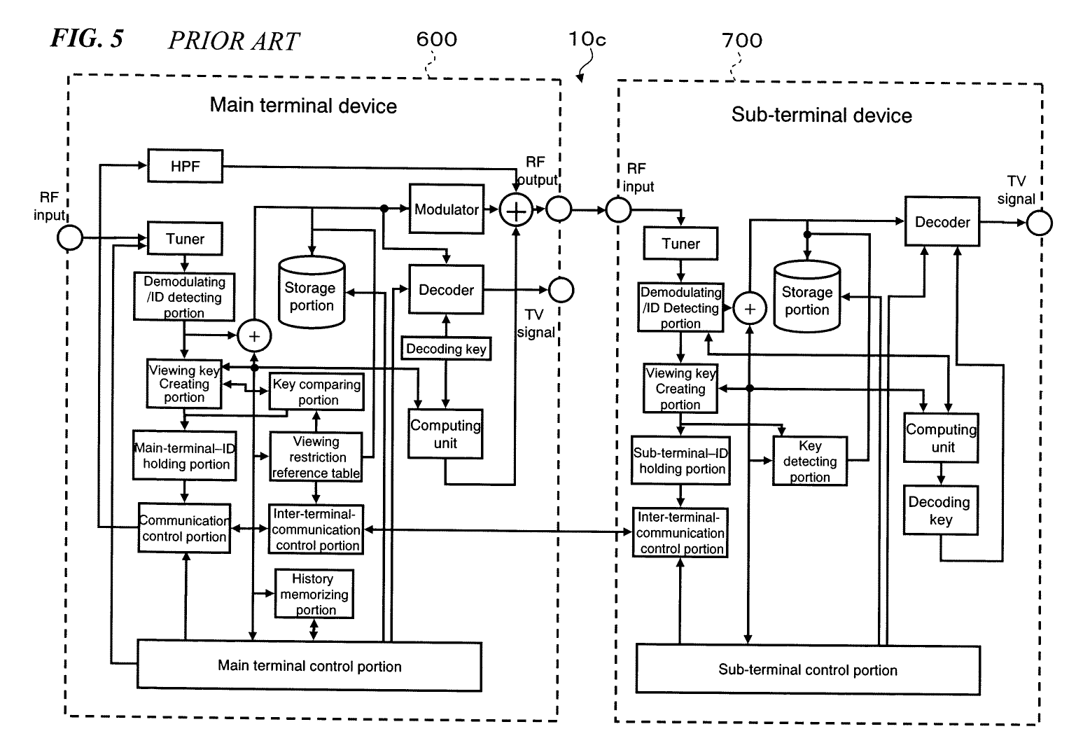

### DETAILED DESCRIPTION OF THE INVENTION

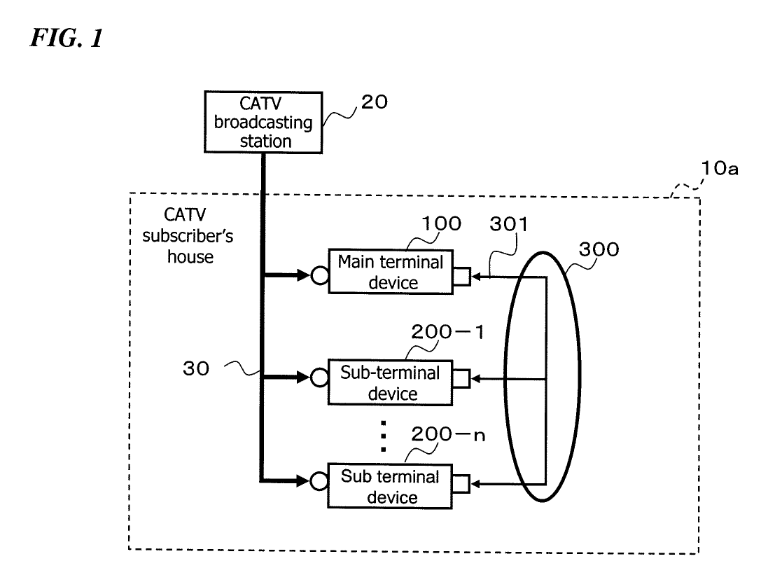

Hereinafter, an in-home receiving terminal system according to an embodiment of the present invention will be described with reference to FIGS. 1, 2, and 3.

FIG. 1 illustrates the basic configuration of the in-home receiving terminal system according to the present embodiment. The in-home receiving terminal system 10a consists of one main terminal device 100 and n sub-terminal devices 200-1 to 200-n (where n is an integer of 2 or higher).

The in-home receiving terminal system 10a is installed in the house of a subscriber (a CATV subscriber's house), and connected to a cable television broadcasting station 20 by a cable television circuit 30. That is, the main terminal device 100 and the sub-terminal devices 200-1 to 200-n are connected to the cable television circuit 30. Note that television programs are distributed via the cable television circuit 30.

In addition, the main terminal device 100 and the sub-terminal devices 200-1 to 200-n are connected to an in-home network 300 via a LAN circuit 301, and furthermore, they are mutually linked via the in-home network 300.

The main terminal device 100 controls communications with the cable television broadcasting station 20. Moreover, the main terminal device 100 notifies the cable television broadcasting station 20 of sub-terminal-device management information upon request from the cable television broadcasting station 20. The sub-terminal-device management information is information concerning management of the sub-terminal devices 200-1 to 200-n under subscriber contract.

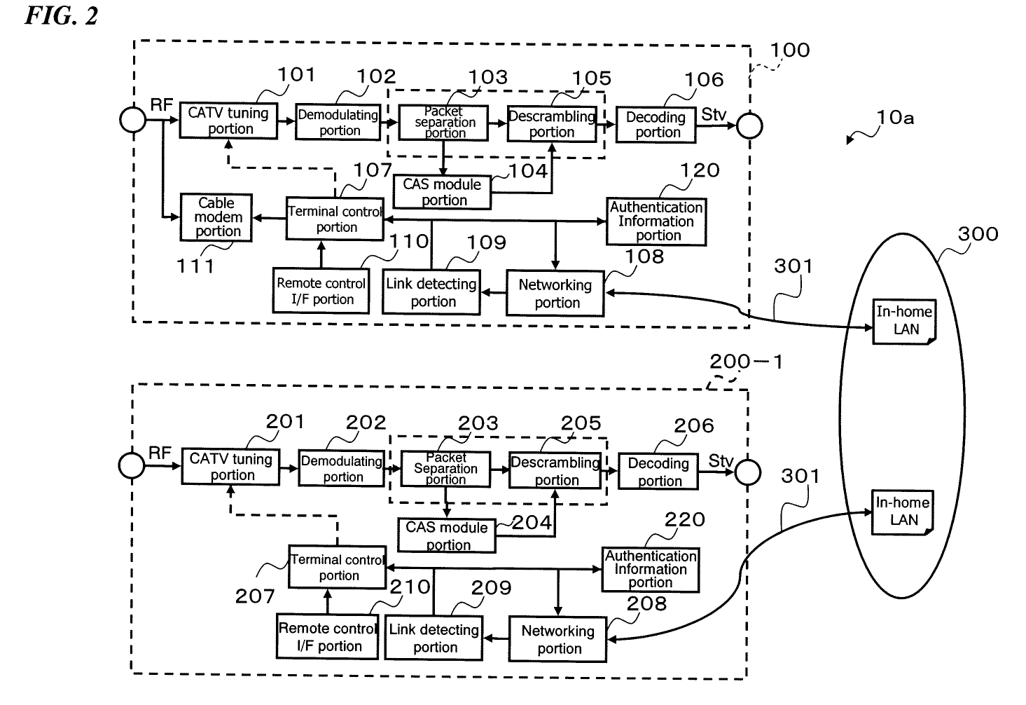

FIG. 2 illustrates concrete configurations of the main terminal device 100 and the sub-terminal device 200-1, which are included in the in-home receiving terminal system 10a. The sub-terminal devices 200-1 to 200-n have the same configuration and functions, and therefore the configuration and operation of the sub-terminal device 200-1 will be described as a representative example with reference to FIG. 2.

The main terminal device 100 includes a CATV tuning portion 101, a demodulating portion 102, a packet separation portion 103, a CAS module portion 104, a descrambling portion 105, a decoding portion 106, a terminal control portion 107, a networking portion 108, a link detecting portion 109, a remote control I/F portion 110, a cable modem portion 111, and an authentication information portion 120.

The CATV tuning portion 101 receives television broadcasting RF broadcast from the cable television broadcasting station 20 via the cable television circuit 30. The demodulating portion 102 outputs a broadcasting stream after demodulating a television program tuned in to by the CATV tuning portion 101. The packet separation portion 103 performs packet separation on the broadcasting stream outputted by the demodulating portion 102, thereby extracting a video stream and CAS information.

The CAS module portion 104 supplies the CAS information extracted by the packet separation portion 103 to the descrambling portion 105 as descrambling information. Based on the descrambling information, the descrambling portion 105 descrambles and supplies the video stream outputted from the packet separation portion 103 to the decoding portion 106. The decoding portion 106 decodes and outputs the descrambled video stream as a television signal Stv.

The terminal control portion 107 controls each block involved in the television receiving function of the main terminal device 100, including the CATV tuning portion 101. The networking portion 108 controls the link connection with the in-home network 300. The link detecting portion 109 detects the status of the networking portion 108, regarding the link connection with the in-home network 300, and notifies the terminal control portion 107 of the status. The remote control I/F portion 110 receives a remote control signal externally generated by a user operation and transmitted to the main terminal device 100. The cable modem portion 111 controls the communication between the cable television broadcasting station 20 and the main terminal device 100. The authentication information portion 120 holds authentication information to be used when the main terminal device 100 establishes the link connection with the in-home network 300 via the networking portion 108.

The sub-terminal device 200-1 includes a CATV tuning portion 201, a demodulating portion 202, a packet separation portion 203, a CAS module portion 204, a descrambling portion 205, a decoding portion 206, a terminal control portion 207, a networking portion 208, a link detecting portion 209, a remote control I/F portion 210, and an authentication information portion 220.

The CATV tuning portion 201 receives television broadcasting RF broadcast from the cable television broadcasting station 20. The demodulating portion 202 demodulates a television program tuned in to by the CATV tuning portion 201. The packet separation portion 203 performs packet separation on a broadcasting stream outputted from the demodulating portion 202. The CAS module portion 204 generates descrambling information based on CAS information extracted by the packet separation portion 203. The descrambling portion 205 descrambles a video stream outputted from the packet separation portion 203 based on the descrambling information generated by the CAS module portion 204.

The decoding portion 206 decodes the video stream descrambled by the descrambling portion 205, and outputs it as a television signal Stv. The terminal control portion 207 controls each block involved in the television receiving function of the sub-terminal device 200-1, including the CATV tuning portion 201. The networking portion 208 controls the link connection with the in-home network 300. The link detecting portion 209 detects the status of the networking portion 208, regarding the link connection with the in-home network 300, and notifies the terminal control portion 207 of the status.

The remote control I/F portion 210 receives a remote control signal externally generated by a user operation and transmitted to the sub-terminal device 200-1. The authentication information portion 220 holds authentication information to be used when the sub-terminal device 200-1 establishes the link connection with the in-home network 300 via the networking portion 208.

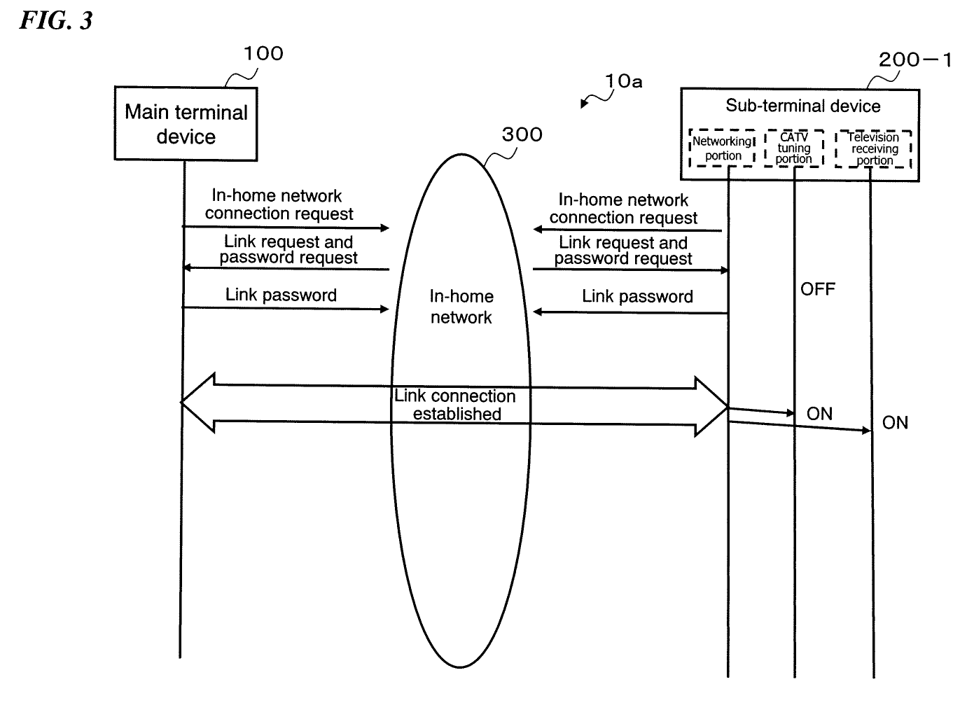

Next, the sequential procedures for the main terminal device 100 and the sub-terminal device 200-1 to establish the link connection with the in-home network 300 will be described with reference to FIG. 3. Described first are the “in-home network” and the “link connection” as used herein.

The functions of the networking portion 108 in the main terminal device 100 can be hierarchically classified into the following three layers: a physical layer, a data link layer, and a layer higher than these layers (hereinafter, referred to as a “higher layer”). The physical layer actually transmits data after converting it into an electric signal. The data link layer ensures reliable data transmission between terminal devices. The higher layer manages communication schemes, and performs communication control related to information transmission. The functions of the networking portion 208 in the sub-terminal device 200-1 are similar to those of the networking portion 108.

The “in-home network” as used herein refers to a network virtually configured by the physical layer and the data link layer from among the functions of the networking portion 108 or 208 in each terminal device, and a cable connected to the terminal device. In addition, the “link connection” as used herein refers to the state in which information can be transmitted between the “in-home network” and the terminal device, and the realization of the state is referred to as the “establishment of the link connection”.

The link connection is realized based on unique authentication information held in each terminal device. That is, the main terminal device 100 and the sub-terminal device 200-1 are connected to the in-home network 300 based on the authentication information. The link connection is realized between the terminal devices (the main terminal device 100 and the sub-terminal device 200-1) having the same authentication information.

An example of the procedure for the main terminal device 100 to establish the link connection with another terminal device (in the present embodiment, the sub-terminal device 200-1) via the in-home network 300 will now be described below. When the main terminal device 100 installed in the subscriber's house is turned ON, the main terminal device 100 makes an in-home network connection request to the in-home network 300 (concretely, the physical layer and the data link layer of the networking portion 208 in the sub-terminal device 200-1) in order to realize the link connection with the in-home network 300. Upon reception of the in-home network connection request, the in-home network 300 responds to the connection request, and transmits a link request and password request to the main terminal device 100. Upon reception of the link request and password request from the in-home network 300, the main terminal device 100 reads a link password, which is authentication information unique to the subscriber, from the authentication information portion 120, and issues it to the in-home network 300, thereby attempting the link connection.

Next, an example of the procedure for the sub-terminal device 200-1 to establish the link connection with another terminal device (in the present embodiment, the main terminal device 100) via the in-home network 300 will be described. The procedure for the sub-terminal device 200-1 to establish the link connection is basically the same as the procedure for the main terminal device 100. When the sub-terminal device 200-1 is turned ON, the sub-terminal device 200-1 makes an in-home network connection request to the in-home network 300 (concretely, the physical layer and the data link layer of the networking portion 108 in the main terminal device 100) in order to realize the link connection with the in-home network 300. Upon reception of the in-home network connection request, the in-home network 300 responds to the connection request, and transmits a link request and password request to the sub-terminal device 200-1.

Upon reception of the link request and password request, the sub-terminal device 200-1 reads a link password, which is authentication information unique to the subscriber, from the authentication information portion 220, and issues it to the in-home network 300, thereby attempting the link connection. In such a manner, the main terminal device 100 and the sub-terminal device 200-1 individually attempt to establish the link connection with the in-home network 300.

When the main terminal device 100 and the sub-terminal device 200-1 hold the same authentication information (link password) within the in-home network 300, the link connection between the main terminal device 100 and the sub-terminal device 200-1 is established over the in-home network 300. As a result, the main terminal device 100 and the sub-terminal device 200-1 are allowed to communicate with each other via the in-home network 300.

Then, the link detecting portion 209 in the sub-terminal device 200-1 detects the status of the link connection with the in-home network 300 (concretely, the link connection with the networking portion 108 of the main terminal device 100), and notifies the terminal control portion 207 of the status. When the link connection is determined to have been established based on the notification, the terminal control portion 207 allows the CATV tuning portion 201 to operate (as indicated by “ON” for the CATV tuning portion in FIG. 3). Consequently, when the sub-terminal device 200-1 from among a plurality of sub-terminal devices under contract is installed in the same house as the main terminal device 100, the sub-terminal device 200-1 can be controlled so that it can receive television broadcasts distributed over the cable television circuit 30 (as indicated by “ON” for the television receiving function in FIG. 3).

On the other hand, when the link connection of the sub-terminal device 200-1 with the in-home network 300 (concretely, the link connection with the networking portion 108 of the main terminal device 100) is determined not to have been established based on the notification from the link detecting portion 209, the terminal control portion 207 does not allow activation of the CATV tuning portion 201. As such, even when the sub-terminal device 200-1 is installed in the same house as the main terminal device 100, if they have different authentication information (link passwords) within the in-home network 300, the sub-terminal device 200-1 is controlled so that it cannot receive television broadcasts distributed via the cable television circuit 30. An example of a case where the authentication information (link password) held by the sub-terminal device 200-1 differs from that of the main terminal device 100 is the case where the sub-terminal device connected to the in-home network 300 is not covered by the contract for the cable television broadcasting subscription.

In addition, when the main terminal device 100 and the sub-terminal device 200-1 are not installed in the same house, the in-home network 300 to which the main terminal device 100 is connected differs from the in-home network 300 to which the sub-terminal device 200-1 is connected. Therefore, no link connection is established between the main terminal device 100 and the sub-terminal device 200-1, so that the sub-terminal device 200-1 is restricted on reception of the cable television broadcasting.

As described above, in the in-home receiving system according to the present invention, when the sub-terminal device is prohibited from establishing the link connection with the in-home network, the television receiving function of the sub-terminal device for receiving television broadcasts distributed via the cable circuit is deactivated. Specifically, only the television receiving function of the sub-terminal device under contract that is installed in the subscriber's house is activated. In addition, even if connected to the cable circuit outside the subscriber's house, the sub-terminal device is prohibited from connecting with the main terminal device in the subscriber's house via the in-home network. Therefore, the television receiving function of the sub-terminal device without the link connection is deactivated, thereby making it possible to prevent unfair reception of television broadcasting.

The present invention can be used for cable television broadcasting systems in which a preferential fee is applied to subscribers who use a plurality of receiving terminal devices.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An in-home receiving terminal system comprising a main terminal device and a sub-terminal device for receiving digital cable television broadcasting, the main terminal device and the sub-terminal device being connected to an in-home network,
wherein the sub-terminal device includes:
a tuning unit for receiving the digital cable television broadcasting;
a link detecting unit for detecting the status of a link connection with the in-home network; and
a terminal control unit for controlling activation/deactivation of the tuning unit based on a notification from the link detecting unit, regarding the status of the link connection.

2. The in-home receiving terminal system according to claim 1, wherein the terminal control unit deactivates the tuning unit when the sub-terminal device is prohibited from establishing the link connection with the in-home network.

3. The in-home receiving terminal system according to claim 2,
wherein the sub-terminal device includes:
an authentication information holding unit for holding first authentication information; and
a networking unit for controlling the link connection with the in-home network, and
wherein the networking unit establishes no link connection with the in-home network when the first authentication information differs from second authentication information issued by the main terminal device.
